(19) United States
(12) Patent Application Publication
(10) Pub. No.: US 2011/0202722 A1
(43) Pub. Date: Aug. 18, 2011

(54) Mass Storage System and Method of Operating Thereof

(75) Inventors: Julian SATRAN, Omer (IL); Yechiel YOCHAI, D.N. Menashe (IL); Haim KOPYLOVITZ, Herzliya (IL); Leo CORRY, Tel Aviv (IL)

(73) Assignee: INFINIDAT LTD., Herzliya (IL)

(21) Appl. No.: 13/008,197

(22) Filed: Jan. 18, 2011

Related U.S. Application Data
(60) Provisional application No. 61/296,320, filed on Jan. 19, 2010.

(51) Int. Cl. G06F 12/08

(52) U.S. Cl. 711/114; 711/E12.019

(57) ABSTRACT

There are provided a storage system and a method of operating thereof. The method comprises: caching in the cache memory a plurality of data portions matching a certain criterion, thereby giving rise to the cached data portions; analyzing the succession of logical addresses characterizing the cached data portions; if the cached data portions cannot constitute a group of N contiguous data portions, where N is the number of RG members, generating a virtual stripe being a concatenation of N data portions wherein at least one data portion among said data portions is non-contiguous with respect to any other portion in the virtual stripe, and wherein the size of the virtual stripe is equal to the size of the stripe of the RAID group; destaging the virtual stripe and writing it to a respective storage device in a write-out-of-place manner. The virtual stripe can be generated responsive to receiving a write request from a client and/or responsive to receiving a write instruction from a background process.

### CROSS-REFERENCES TO RELATED APPLICATIONS

This application relates to and claims priority from U.S. Provisional Patent Application No. 61/296,320 filed on Jan. 19, 2010 incorporated herein by reference in its entirety.

### FIELD OF THE INVENTION

The present invention relates, in general, to data storage systems and respective methods for data storage, and, more particularly, to storage systems with implemented RAID protection and methods of operating thereof.

### BACKGROUND OF THE INVENTION

Modern enterprises are investing significant resources to preserve and provide access to data. Data protection is a growing concern for businesses of all sizes. Users are looking for a solution that will help to verify that critical data elements are protected, and storage configuration can enable data integrity and provide a reliable and safe switch to redundant computing resources in case of an unexpected disaster or service disruption.

To accomplish this, storage systems may be designed as fault tolerant systems spreading data redundantly across a set of storage-nodes and enabling continuous operation when a hardware failure occurs. Fault tolerant data storage systems may store data across a plurality of disk drives and may include duplicate data, parity or other information that may be employed to reconstruct data if a drive fails. Data storage formats, such as RAID (Redundant Array of Independent Discs), may be employed to protect data from internal component failures by making copies of data and rebuilding lost or damaged data.

Although the RAID-based storage architecture provides data protection, modifying a data block on a disk requires multiple read and write operations. The problems of optimizing write operations in RAID-based storage systems have been recognized in the Conventional Art and various systems have been developed to provide a solution, for example:

US Patent Application No. 2008/109616 (Taylor) discloses a parity protection system, comprising: a zeroing module configured to initiate a zeroing process on a plurality of storage devices in the parity protection system by issuing a zeroing command, wherein the parity protection system comprises a processor and a memory; a storage module coupled to the zeroing module configured to execute the zeroing command to cause free physical data blocks identified by the command to assume a zero value; and in response to the free physical data blocks assuming zero values, a controller module to update a parity for one or more stripes in the parity protection system that contain data blocks zeroed by the zeroing command; wherein the storage module in response to an access request from a client, comprising a write operation and associated data, is configured to access the free physical data blocks and to write the data thereto and compute a new parity for one or more stripes associated with the write operation without reading the zeroed physical data blocks to which the data are written.

US Patent application No. 2005/246382 (Edwards) discloses a write allocation technique extending a conventional write allocation procedure employed by a write anywhere file system of a storage system. A write allocator of the file system implements the extended write allocation technique in response to an event in the file system. The extended write allocation technique allocates blocks, and frees blocks, to and from a virtual volume (VVOL) of an aggregate. The aggregate is a physical volume comprising one or more groups of disks, such as RAID groups, underlying one or more VVOLs of the storage system. The aggregate has its own physical volume block number (PVBN) space and maintains metadata, such as block allocation structures, within that PVBN space. Each VVOL also has its own virtual volume block number (VVBN) space and maintains metadata, such as block allocation structures, within that VVBN space.

### SUMMARY OF THE INVENTION

In accordance with certain aspects of the presently disclosed subject matter, there is provided a method of operating a storage system comprising a control layer comprising a cache memory and operatively coupled to a plurality of storage devices constituting a physical storage space configured as a concatenation of a plurality of RAID groups (RG), each RAID group comprising N RG members. The method comprises: caching in the cache memory a plurality of data portions matching a certain criterion, thereby giving rise to the cached data portions and analyzing the succession of logical addresses characterizing the cached data portions. If the cached data portions cannot constitute a group of N contiguous data portions, where N is the number of RG members, generating a virtual stripe, destaging the virtual stripe and writing it to a respective storage device in a write-out-of-place manner. The virtual stripe is a concatenation of N data portions wherein at least one data portion among said data portions is non-contiguous with respect to any other portion in the virtual stripe, and wherein the size of the virtual stripe is equal to the size of the stripe of the RAID group.

The data portions in the virtual stripe can further meet a consolidation criterion (e.g. criteria related to different characteristics of cached data portions and/or criteria related to desired storage location of the generated virtual stripe, etc.).

The virtual stripe can be generated responsive to receiving a given write request from a client. The cached data portions can be constituted by data portions corresponding to the given write request and data portions corresponding to one or more write requests received before the given write request; by data portions corresponding to the given write request, data portions corresponding to one or more write requests received before the given write request and data portions corresponding to one or more write requests received during a certain period of time after receiving the given write request; by data portions corresponding to the given write request, and data portions corresponding to one or more write requests received during a certain period of time after receiving the given write request, etc.

Alternatively or additionally, the virtual stripe can be generated responsive to receiving a write instruction from a background process (e.g. defragmentation process, compression process, de-duplication process, scrubbing process, etc.). Optionally, the cached data portions can meet a criterion related to the background process.

In accordance with further aspects of the presently disclosed subject matter, if the control layer comprises a first virtual layer operable to represent the cached data portions with the help of virtual unit addresses corresponding to respective logical addresses, and a second virtual layer operable to represent the cached data portions with the help of virtual disk addresses (VDAs) substantially statically mapped into addresses in the physical storage space, the method further comprises: configuring the second virtual layer as a concatenation of representations of the RAID groups; generating the virtual stripe with the help of translating at least partly non-sequential virtual unit addresses characterizing data portions in the stripe into sequential virtual disk addresses, so that the data portions in the virtual stripe become contiguously represented in the second virtual layer; and translating sequential virtual disk addresses into physical storage addresses of the respective RAID group statically mapped to second virtual layer, thereby enabling writing the virtual stripe to the storage device.

In accordance with other aspects of the presently disclosed subject matter, there is provided a storage system comprising a control layer operatively coupled to a plurality of storage devices constituting a physical storage space configured as a concatenation of a plurality of RAID groups (RG), each RAID group comprising N RG members. The control layer comprises a cache memory and is further operable:
to cache in the cache memory a plurality of data portions matching a certain criterion, thereby giving rise to the cached data portions;
to analyze the succession of logical addresses characterizing the cached data portions;
if the cached data portions cannot constitute a group of N contiguous data portions, where N is the number of RG members, to generate a virtual stripe being a concatenation of N data portions wherein at least one data portion among said data portions is non-contiguous with respect to any other portion in the virtual stripe, and wherein the size of the virtual stripe is equal to the size of the stripe of the RAID group;
to destage the virtual stripe and to enable writing the virtual stripe to a respective storage device in a write-out-of-place manner.

The data portions in the virtual stripe can further meet a consolidation criterion (e.g. criteria related to different characteristics of cached data portions and/or criteria related to desired storage location of the generated virtual stripe, etc.).

The control layer can be further operable to generate the virtual stripe responsive to receiving a write request from a client. Alternatively or additionally, the control layer is operable to generate the virtual stripe responsive to receiving a write instruction from a background process (e.g. defragmentation process, compression process, de-duplication process, scrubbing process, etc.). Optionally, the cached data portions can meet a criterion related to the background process.

In accordance with further aspects of the presently disclosed subject matter, the control layer can further comprise a first virtual layer operable to represent the cached data portions with the help of virtual unit addresses corresponding to respective logical addresses, and a second virtual layer operable to represent the cached data portions with the help of virtual disk addresses (VDAs) substantially statically mapped into addresses in the physical storage space, said second virtual layer is configured as a concatenation of representations of the RAID groups. The control layer can be further operable to generate the virtual stripe with the help of translating at least partly non-sequential virtual unit addresses characterizing data portions in the stripe into sequential virtual disk addresses, so that the data portions in the virtual stripe become contiguously represented in the second virtual layer; and to translate sequential virtual disk addresses into physical storage addresses of a respective RAID group statically mapped to second virtual layer, thereby enabling writing the virtual stripe to the storage device.

Among advantages of certain embodiments of the presently disclosed subject matter is optimizing the process of writing arbitrary requests in RAID-configured storage systems.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a generalized functional block diagram of a mass storage system where the presently disclosed subject matter can be implemented;

FIG. 2 illustrates a schematic diagram of storage space configured in RAID groups as known in the art;

FIG. 3 illustrates a generalized flow-chart of operating the storage system in accordance with certain embodiments of the presently disclosed subject matter;

FIG. 4 illustrates a generalized flow-chart of operating the storage system in accordance with other certain embodiments of the presently disclosed subject matter;

FIG. 5 illustrates a schematic functional diagram of the control layer where the presently disclosed subject matter can be implemented; and

FIG. 6 illustrates a schematic diagram of generating a virtual stripe in accordance with certain embodiments of the presently disclosed subject matter.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “activating”, “translating”, “writing”, “selecting”, “allocating”, “storing”, “managing” or the like, refer to the action and/or processes of a computer that manipulate and/or transform data into other data, said data represented as physical, such as electronic, quantities and/or said data representing the physical objects. The term “computer” should be expansively construed to cover any kind of electronic system with data processing capabilities, including, by way of non-limiting example, storage system and parts thereof disclosed in the present applications.

The term “criterion” used in this patent specification should be expansively construed to include any compound criterion, including, for example, several criteria and/or their logical combinations.

The operations in accordance with the teachings herein may be performed by a computer specially constructed for the desired purposes or by a general-purpose computer specially configured for the desired purpose by a computer program stored in a computer readable storage medium.

Embodiments of the present invention are not described with reference to any particular programming language. It will be appreciated that a variety of programming languages may be used to implement the teachings of the inventions as described herein.

The references cited in the background teach many principles of operating a storage system that are applicable to the presently disclosed subject matter. Therefore the full contents of these publications are incorporated by reference herein where appropriate for appropriate teachings of additional or alternative details, features and/or technical background.

In the drawings and descriptions, identical reference numerals indicate those components that are common to different embodiments or configurations.

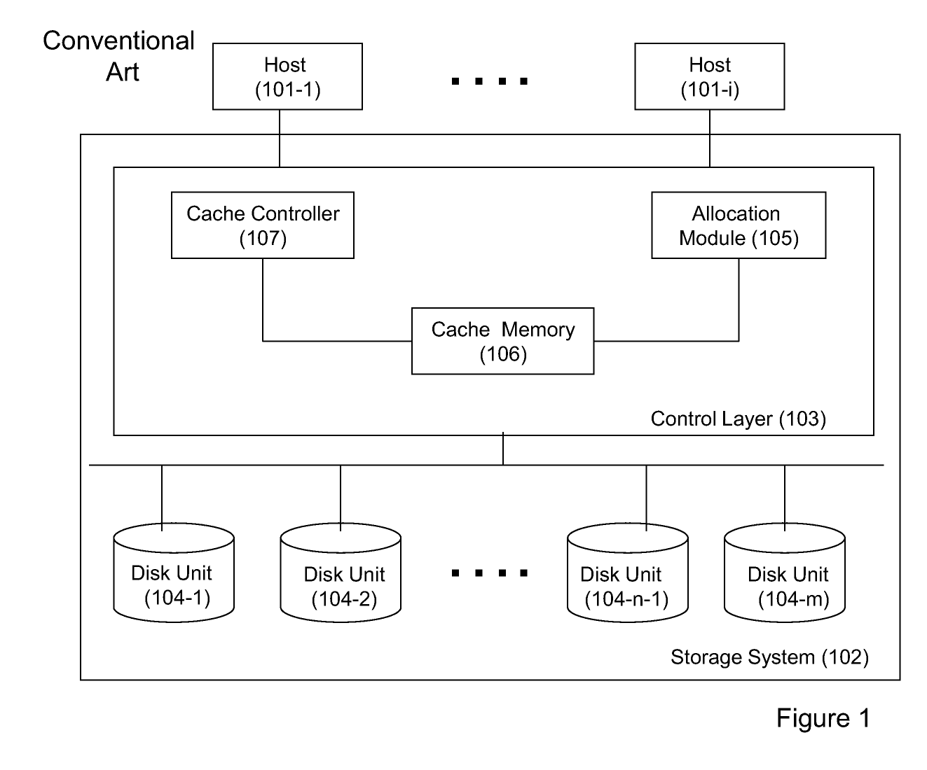

Bearing this in mind, attention is drawn to FIG. 1 illustrating an exemplary storage system as known in the art.

The plurality of host computers (workstations, application servers, etc.) illustrated as 101-1-101-n share common storage means provided by a storage system 102. The storage system comprises a storage control layer 103 comprising one or more appropriate storage control devices operatively coupled to the plurality of host computers and a plurality of data storage devices 104-1-104-m constituting a physical storage space optionally distributed over one or more storage nodes, wherein the storage control layer is operable to control interface operations (including I/O operations) there between. The storage control layer is further operable to handle a virtual representation of physical storage space and to facilitate necessary mapping between the physical storage space and its virtual representation. The virtualization functions may be provided in hardware, software, firmware or any suitable combination thereof. Optionally, the functions of the control layer may be fully or partly integrated with one or more host computers and/or storage devices and/or with one or more communication devices enabling communication between the hosts and the storage devices. Optionally, a format of logical representation provided by the control layer may differ depending on interfacing applications.

The physical storage space may comprise any appropriate permanent storage medium and include, by way of non-limiting example, one or more disk drives and/or one or more disk units (DUs), comprising several disks. The storage control layer and the storage devices may communicate with the host computers and within the storage system in accordance with any appropriate storage protocol.

Stored data may be logically represented to a client in terms of logical objects. Depending on storage protocol, the logical objects may be logical volumes, data files, image files, etc. For purpose of illustration only, the following description is provided with respect to logical objects represented by logical volumes. Those skilled in the art will readily appreciate that the teachings of the present invention are applicable in a similar manner to other logical objects.

A logical volume or logical unit (LU) is a virtual entity logically presented to a client as a single virtual storage device. The logical volume represents a plurality of data blocks characterized by successive Logical Block Addresses (LBA) ranging from 0 to a number LUK. Different LUs may comprise different numbers of data blocks, while the data blocks are typically of equal size (e.g. 512 bytes). Blocks with successive LBAs may be grouped into portions that act as basic units for data handling and organization within the system. Thus, for instance, whenever space has to be allocated on a disk or on a memory component in order to store data, this allocation may be done in terms of data portions also referred to hereinafter as “allocation units”. Data portions are typically of equal size throughout the system (by way of non-limiting example, the size of data portion may be 64 Kbytes).

The storage control layer may be further configured to facilitate various protection schemes. By way of non-limiting example, data storage formats, such as RAID (Redundant Array of Independent Discs), may be employed to protect data from internal component failures by making copies of data and rebuilding lost or damaged data. As the likelihood for two concurrent failures increases with the growth of disk array sizes and increasing disk densities, data protection may be implemented, by way of non-limiting example, with the RAID 6 data protection scheme well known in the art.

Common to all RAID 6 protection schemes is the use of two parity data portions per several data groups (e.g. using groups of four data portions plus two parity portions in (4+2) protection scheme), the two parities being typically calculated by two different methods. Under one known approach, all N consecutive data portions are gathered to form a RAID group, to which two parity portions are associated. The members of a group as well as their parity portions are typically stored in separate drives. Under a second known approach, protection groups may be arranged as two-dimensional arrays, typically n*n, such that data portions in a given line or column of the array are stored in separate disk drives. In addition, to every row and to every column of the array a parity data portion may be associated. These parity portions are stored in such a way that the parity portion associated with a given column or row in the array resides in a disk drive where no other data portion of the same column or row also resides. Under both approaches, whenever data is written to a data portion in a group, the parity portions are also updated (e.g. using techniques based on XOR or Reed-Solomon algorithms). Whenever a data portion in a group becomes unavailable (e.g. because of disk drive general malfunction, or because of a local problem affecting the portion alone, or because of other reasons), the data can still be recovered with the help of one parity portion via appropriate known in the art techniques. Then, if a second malfunction causes data unavailability in the same drive before the first problem was repaired, data can nevertheless be recovered using the second parity portion and appropriate known in the art techniques.

The storage control layer can further comprise an Allocation Module 105, a Cache Memory 106 operable as part of the IO flow in the system, and a Cache Control Module 107, that regulates data activity in the cache.

The allocation module, the cache memory and the cache control module may be implemented as centralized modules operatively connected to the plurality of storage control devices or may be distributed over a part or all storage control devices.

Typically, definition of LUs and/or other objects in the storage system may involve in-advance configuring an allocation scheme and/or allocation function used to determine the location of the various data portions and their associated parity portions across the physical storage medium. Sometimes, like in the case of thin volumes or snapshots, the pre-configured allocation is only performed when a write command is directed for the first time after definition of the volume, at a certain block or data portion in it.

An alternative known approach is a log-structured storage based on an append-only sequence of data entries. Whenever the need arises to write new data, instead of finding a formerly allocated location for it on the disk, the storage system appends the data to the end of the log. Indexing the data may be accomplished in a similar way (e.g. metadata updates may be also appended to the log) or may be handled in a separate data structure (e.g. index table).

Storage devices, accordingly, can be configured to support write-in-place and/or write-out-of-place techniques. In a write-in-place technique modified data is written back to its original physical location on the disk, overwriting the older data. In contrast, a write-out-of-place technique writes (e.g. in a log form) a modified data block to a new physical location on the disk. Thus, when data is modified after being read to memory from a location on a disk, the modified data is written to a new physical location on the disk so that the previous, unmodified version of the data is retained. A non-limiting example of the write-out-of-place technique is the known write-anywhere technique, enabling writing data blocks to any available disk without prior allocation.

When receiving a write request from a host, the storage control layer defines a physical location(s) for writing the respective data (e.g. a location designated in accordance with an allocation scheme, preconfigured rules and policies stored in the allocation module or otherwise and/or location available for a log-structured storage).

When receiving a read request from the host, the storage control layer defines the physical location(s) of the desired data and further processes the request accordingly. Similarly, the storage control layer issues updates to a given data object to all storage nodes which physically store data related to said data object. The storage control layer is further operable to redirect the request/update to storage device(s) with appropriate storage location(s) irrespective of the specific storage control device receiving I/O request.

For purpose of illustration only, the operation of the storage system is described herein in terms of entire data portions. Those skilled in the art will readily appreciate that the teachings of the present invention are applicable in a similar manner to partial data portions.

Certain embodiments of the presently disclosed subject matter are applicable to the architecture of a computer system described with reference to FIG. 1. However, the invention is not bound by the specific architecture; equivalent and/or modified functionality can be consolidated or divided in another manner and can be implemented in any appropriate combination of software, firmware and hardware. Those versed in the art will readily appreciate that the invention is, likewise, applicable to any computer system and any storage architecture implementing a virtualized storage system. In different embodiments of the presently disclosed subject matter the functional blocks and/or parts thereof may be placed in a single or in multiple geographical locations (including duplication for high-availability); operative connections between the blocks and/or within the blocks may be implemented directly (e.g. via a bus) or indirectly, including remote connection. The remote connection may be provided via Wire-line, Wireless, cable, Internet, Intranet, power, satellite or other networks and/or using any appropriate communication standard, system and/or protocol and variants or evolution thereof (as, by way of unlimited example, Ethernet, iSCSI, Fiber Channel, etc.). By way of non-limiting example, the invention may be implemented in a SAS grid storage system disclosed in U.S. patent application Ser. No. 12/544,743 filed on Aug. 20, 2009, assigned to the assignee of the present application and incorporated herein by reference in its entirety.

For purpose of illustration only, the following description is made with respect to RAID 6 architecture. Those skilled in the art will readily appreciate that the teachings of the presently disclosed subject matter are not bound by RAID 6 and are applicable in a similar manner to other RAID technology in a variety of implementations and form factors.

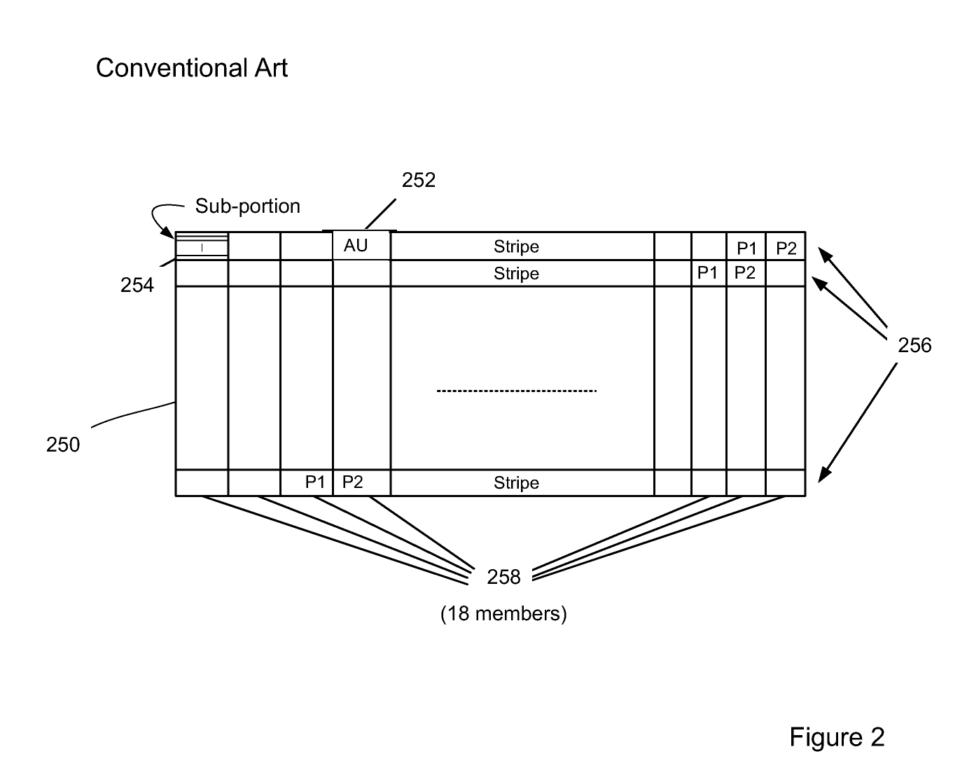

Referring to FIG. 2, there is illustrated a schematic diagram of storage space configured in RAID groups as known in the art. A RAID group (250) can be built as a concatenation of stripes (256), the stripe being a complete (connected) set of data and parity elements that are dependently related by parity computation relations. In other words, the stripe is the unit within which the RAID write and recovery algorithms are performed in the system. A stripe comprises N+2 data portions (252), the data portions being the intersection of a stripe with a member (256) of the RAID group. A typical size of the data portions is 64 KByte (or 128 blocks). Each data portion is further sub-divided into 16 sub-portions (254) each of 4 Kbyte (or 8 blocks). Data portions and sub-portions (referred to hereinafter also as “allocation units”) are used to calculate the two parity data portions associated with each stripe. In an example with N=16, and with a typical size of 4 GB for each group member, the RAID group can typically comprise (4*16=) 64 GB of data. A typical size of the RAID group, including the parity blocks, can be of (4*18=) 72 GB.

Each RG comprises N+2 members, MEMi (0≦i≦N+1), with N being the number of data portions per RG (e.g. N=16). The storage system is configured to allocate data (e.g. with the help of the allocation module 105) associated with the RAID groups over various physical drives.

In a traditional approach when each write request is independently written to the cache, completing the write operation requires reading the parity portions already stored somewhere in the system and recalculating their values in view of the newly incoming data. Moreover, the recalculated parity blocks must also be stored once again. Thus, writing less than an entire stripe requires additional read-modify-write operations just in order to read-modify-write the parity blocks.

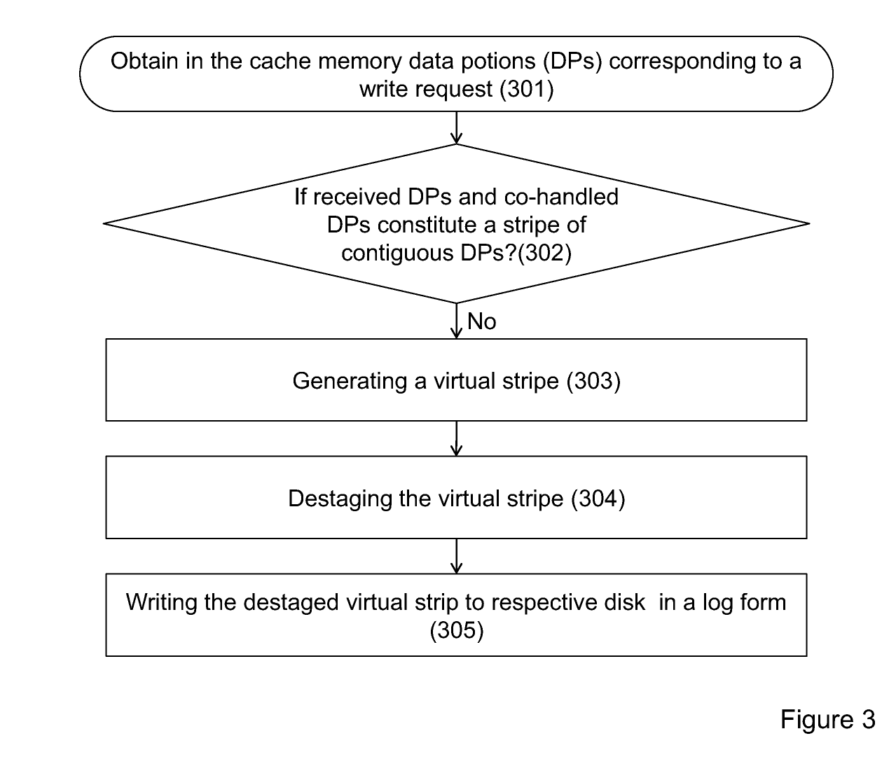

In accordance with certain embodiments of the presently disclosed subject matter and as further detailed with reference to FIGS. 3-5, one or more incoming arbitrary write requests are combined, before destaging, in a manner enabling a direct associating the combined write request to an entire stripe within a RAID group. Accordingly, the two parity portions can be directly calculated within the cache before destaging, and without having to read any data or additional parity already stored in the disks.

For purpose of illustration only, the following description is made with respect to write requests comprising less than N contiguous data portions, where N is a number of members of the RG. Those skilled in the art will readily appreciate that the teachings of the presently disclosed subject matter are not bound by such write requests and are applicable to any part of a write request which does not correspond to the entire stripe of contiguous data portions.

FIG. 3 illustrates a generalized flow-chart of operating the storage system in accordance with certain embodiments of the presently disclosed subject matter. Upon obtaining (301) an incoming write request in the cache memory, the cache controller 106 (or other appropriate functional block in the control layer) analyses the succession (with regard to addresses in the respective logical volume) of the data portion(s) corresponding to the obtained write request and data portions co-handled with the write request. The data portions co-handled with a given write request are constituted by data portions from previous write request(s) and cached in the memory at the moment of obtaining the given write request, and data portions arising in the cache memory from further write request(s) received during a certain period of time after obtaining the given write request. The period of time may be pre-defined (e.g. 1 second) and/or adjusted dynamically according to certain parameters (e.g. overall workload, level of dirty data in the cache, etc.) related to the overall performance conditions in the storage system. Two data portions are considered as contiguous, if, with regard to addresses in the respective logical volume, data in one data portion precedes or follows data in the another data portion.

The cache controller analyses (302) if at least part of data portions in the received write request and at least part of co-handled data portions can constitute a group of N contiguous data portions, where N is the number of members of the RG. If YES, the cash controller consolidates respective data portions in the group of N contiguous data portions and enables writing the consolidated group to the disk with the help of any appropriate technique known in the art (e.g. by generating a consolidated write request built of N contiguous data portions and writing the request in the out-of-place technique).

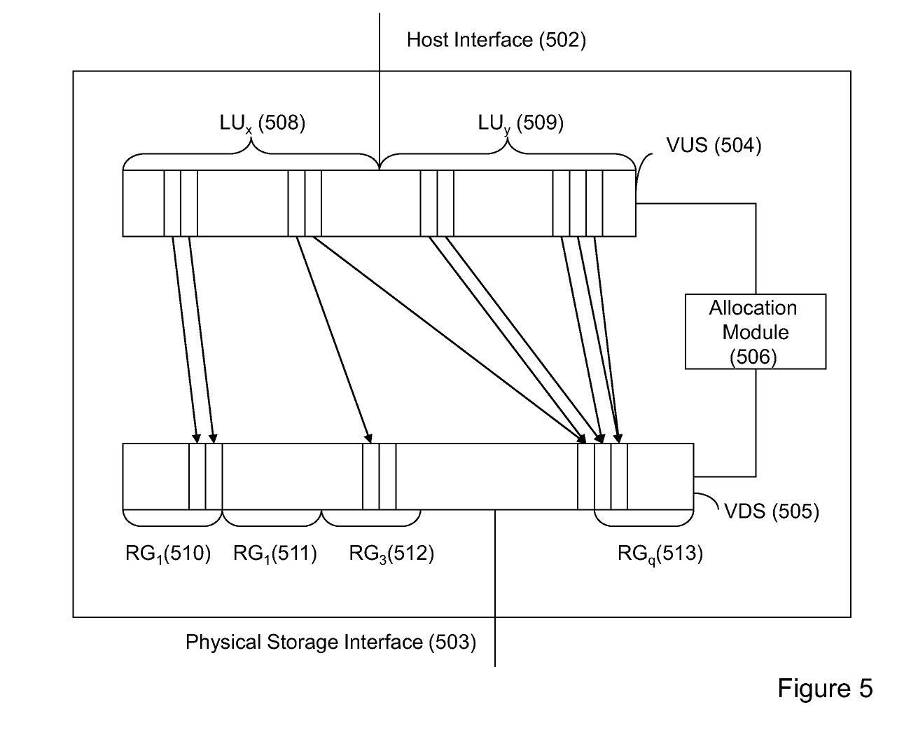

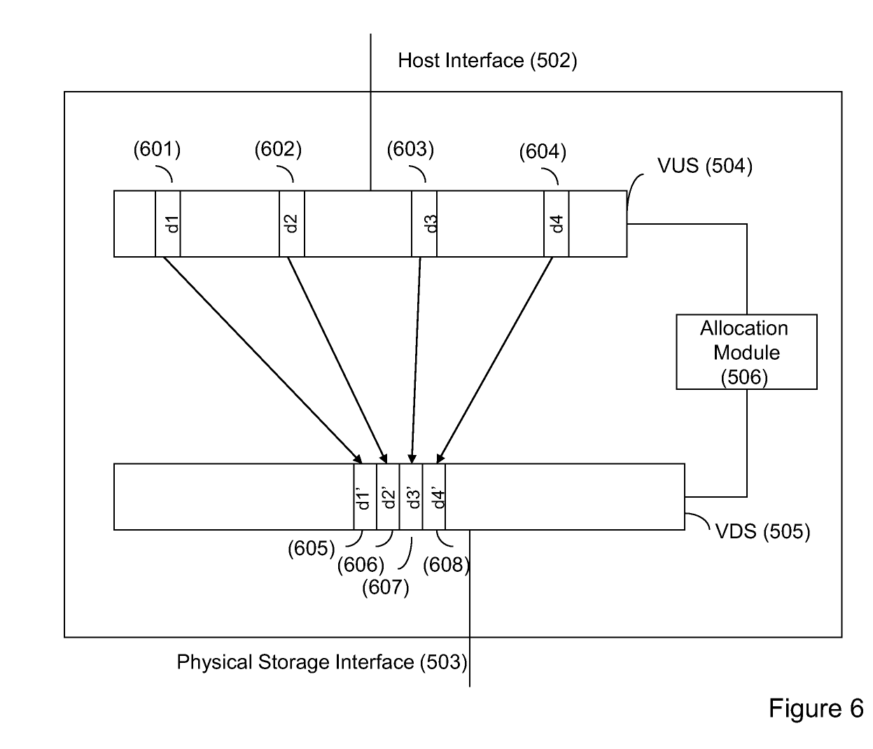

If data portions in the received write request and co-handled data portions cannot constitute a group of N contiguous data portions, where N is the number of members of the RG, the write request is handled in accordance with certain embodiments of the currently presented subject matter as disclosed below. The cache controller enables grouping (303) the cached data portions related to the obtained write requests with co-handled data portions in a consolidated write request, thereby creating a virtual stripe comprising N data portions. The virtual stripe is a concatenation of N data portions corresponding to the consolidated write request, wherein at least one data portion in the virtual stripe is non-contiguous with respect to any other portion in the virtual stripe, and wherein the size of the virtual stripe is equal to the size of the stripe of the RAID group. A non-limiting example of a process of generating the virtual stripes is further detailed with reference to FIGS. 5-6.

Optionally, the virtual stripe can be generated to include data portions of a given write request and following write requests, while excluding data portions cached in the cache memory before receiving the given write request. Alternatively, the virtual stripe can be generated to include merely data portions of a given write request and data portions cached in the cache memory before receiving the given write request.

Optionally, data portions can be combined in virtual stripes in accordance with pre-defined consolidation criterion. The consolidation criteria can be related to different characteristics of data portions (e.g. source of data portions, type of data in data portions, frequency characteristics of data portion, etc.) and or consolidated write request (e.g. storage location). Different non-limiting examples of consolidation criterion are disclosed in U.S. Provisional Patent Application No. 61/360,622 filed on Jul. 1, 2010; U.S. Provisional Patent Application No. 61/360,660 filed on Jul. 1, 2010, and U.S. Provisional Patent Application No. 61/391,657 filed on Oct. 10, 2010, assigned to the assignee of the present application and incorporated herein by reference in its entirety.

The cache controller further enables destaging (304) the virtual stripe and writing (305) it to a respective disk in a write-out-of-place manner (e.g. in a log form). The storage system can be further configured to maintain in the cache memory a Log Write file with necessary description of the virtual stripe.

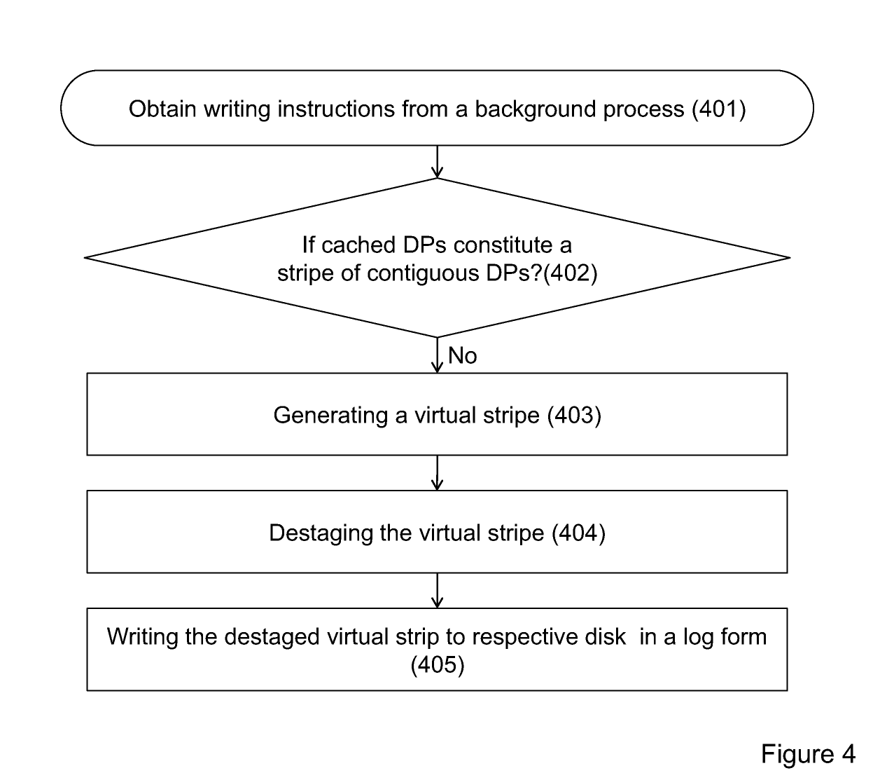

Likewise, in other certain embodiments of the presently disclosed subject matter, the virtual stripe can be generated responsive to an instruction received from a background process (e.g. defragmentation process, de-duplication process, compression process, scrubbing process, etc.) as illustrated in FIG. 4.

Upon obtaining (401) a write instruction from a respective background process, the cache controller 106 (or other appropriate functional block in the control layer) analyses the succession of logical addresses characterizing data portions cached in the cache memory at the moment of receiving the instruction and/or data portions arrived to the cache memory during a certain period of time.

The cache controller examines (402) if at least part of the analyzed data portions can constitute a group of N contiguous data portions, where N is the number of members of the RG. If YES, the cash controller consolidates respective data portions in the group of N contiguous data portions and enables writing the consolidated group to the disk with the help of any appropriate technique known in the art (e.g. by generating a consolidated write request built of N contiguous data portions and writing the request in the out-of-place technique).

If the analyzed data portions cannot constitute a group of N contiguous data portions, where N is the number of members of the RG, the cache controller enables grouping (403) N cached data portions in a consolidated write request, thereby creating a virtual stripe comprising N data portions. The virtual stripe is a concatenation of N data portions corresponding to the consolidated write request, wherein at least one data portion in the virtual stripe is non-contiguous with respect to any other portion in the virtual stripe, and wherein the size of the virtual stripe is equal to the size of the stripe of the RAID group. Optionally, the cached data portions can be grouped in the consolidated write request in accordance with a certain criterion related to the respective background process.

Virtualized architecture further detailed with reference to FIGS. 5-6, enables optimization of grouping non-contiguous data portions and pre-fetching the virtual stripes.

Referring to FIG. 5, there is illustrated a schematic functional diagram of a control layer configured in accordance with certain embodiments of the presently disclosed subject matter. The illustrated configuration is further detailed in U.S. application Ser. No. 12/897,119 filed Oct. 4, 2010, assigned to the assignee of the present application and incorporated herein by reference in its entirety.

The virtual presentation of the entire physical storage space is provided through creation and management of at least two interconnected virtualization layers: a first virtual layer 504 interfacing via a host interface 502 with elements of the computer system (host computers, etc.) external to the storage system, and a second virtual layer 505 interfacing with the physical storage space via a physical storage interface 503. The first virtual layer 504 is operative to represent logical units available to clients (workstations, applications servers, etc.) and is characterized by a Virtual Unit Space (VUS). The logical units are represented in VUS as virtual data blocks characterized by virtual unit addresses (VUAs). The second virtual layer 505 is operative to represent the physical storage space available to the clients and is characterized by a Virtual Disk Space (VDS). By way of non-limiting example, storage space available for clients can be calculated as the entire physical storage space less reserved parity space and less spare storage space. The virtual data blocks are represented in VDS with the help of virtual disk addresses (VDAs). Virtual disk addresses are substantially statically mapped into addresses in the physical storage space. This mapping can be changed responsive to modifications of physical configuration of the storage system (e.g. by disk failure of disk addition). The VDS can be further configured as a concatenation of representations (illustrated as 510-513) of RAID groups.

The first virtual layer (VUS) and the second virtual layer (VDS) are interconnected, and addresses in VUS can be dynamically mapped into addresses in VDS. The translation can be provided with the help of the allocation module 506 operative to provide translation from VUA to VDA via Virtual Address Mapping. By way of non-limiting example, the Virtual Address Mapping can be provided with the help of an address tie detailed in U.S. application Ser. No. 12/897,119 filed Oct. 4, 2010 and assigned to the assignee of the present application.

By way of non-limiting example, FIG. 5 illustrates a part of the storage control layer corresponding to two LUs illustrated as LUx (508) and LUy (509). The LUs are mapped into the VUS. In a typical case, initially the storage system assigns to a LU contiguous addresses (VUAs) in VUS. However, existing LUs can be enlarged, reduced or deleted, and some new ones can be defined during the lifetime of the system. Accordingly, the range of contiguous data blocks associated with the LU can correspond to non-contiguous data blocks assigned in the VUS. The parameters defining the request in terms of LUs are translated into parameters defining the request in the VUAs, and parameters defining the request in terms of VUAs are further translated into parameters defining the request in the VDS in terms of VDAs and further translated into physical storage addresses.

Translating addresses of data blocks in LUs into addresses (VUAs) in VUS can be provided independently from translating addresses (VDA) in VDS into the physical storage addresses. Such translation can be provided, by way of non-limited examples, with the help of an independently managed VUS allocation table and a VDS allocation table handled in the allocation module 506. Different blocks in VUS can be associated with one and the same block in VDS, while allocation of physical storage space can be provided only responsive to destaging respective data from the cache memory to the disks (e.g. for snapshots, thin volumes, etc.).

Referring to FIG. 6, there is illustrated a schematic diagram of generating a virtual stripe with the help of control layer illustrated with reference to FIG. 5. As illustrated by way of non-limiting example in FIG. 6, non-contiguous data portions d1-d4 corresponding to one or more write requests are represented in VUS by non-contiguous sets of data blocks 601-604. VUA addresses of data blocks (VUA, block_count) correspond to the received write request(s) (LBA, block_count). The control layer further allocates to the data portions d1-d4 virtual disk space (VDA, block_count) by translation of VUA addresses into VDA addresses. When generating a virtual stripe comprising data portions d1-d4, VUA addresses are translated into sequential VDA addresses so that data portions become contiguously represented in VDS (605-608). When writing the virtual stripe to the disk, sequential VDA addresses are further translated into physical storage addresses of respective RAID group statically mapped to VDA. Write requests consolidated in more than one stripe can be presented in VDS as consecutive stripes of the same RG.

Likewise, the control layer illustrated with reference to FIG. 5 can enable recognizing by a background (e.g. defragmentation) process non-contiguous VUA addresses of data portions, and further translating such VUA addresses into sequential VDA addresses so that data portions become contiguously represented in VDS when generating respective virtual stripe.

By way of non-limiting example, allocation of VDA for the virtual stripe can be provided with the help of VDA allocator (not shown) comprised in the allocation block or in any other appropriate functional block.

Typically, a mass storage system comprises more than 1000 RAID groups. The VDA allocator is configured to enable writing the generated virtual stripe to a RAID group matching predefined criteria. By way of non-limiting example, the criteria can be related to a status characterizing the RAID groups. The status can be selected from a list comprising:
Ready
Active
Need Garbage Collection (NGC)
Currently in Garbage Collection (IGC)
Need Rebuild
In Rebuild

The VDA allocator is configured to select RG matching the predefined criteria, to select the address of the next available free stripe within the selected RG and allocate VDA addresses corresponding to this available stripe. Selection of RG for allocation of VDA can be provided responsive to generating the respective virtual stripe to be written and/or as a background process performed by the VDA allocator.

The process of RAID Group selection can comprise the following steps:

Initially, all RGs are defined in the storage system with the status “Ready”.

The VDA allocator further randomly selects among the “Ready” RGs a predefined number of RGs (e.g. eight) to be configured as “Active”.

The VDA allocator further estimates an expected performance of each “Active RG” and selects the RAID group with the best-expected performance. Such RG is considered as matching the predefined criteria and is used for writing the respective stripe.

Performance estimation can be provided based on analyzing the recent performance of “Active” RGs so as to find the one in which the next write request is likely to perform best. The analysis can further include a “weighed classification” mechanism that produces a smooth passage from one candidate to the next, i.e. enables slowing down the changes in performance and changes of the selected RG.

The VDA allocator can be further configured to attempt to allocate in the selected RG a predefined number (e.g. four) of consecutive stripes for future writing. If the selected RG does not comprise the predefined number of available consecutive stripes, the VDA allocator changes the status of RG to “Need Garbage Collection”. VDA allocator can re-configure RGs configured as “Need Garbage Collection” to “Active” status without having to undergo the process of garbage collection.

It is to be understood that the presently disclosed subject matter is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present invention.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A method of operating a storage system comprising a control layer comprising a cache memory and operatively coupled to a plurality of storage devices constituting a physical storage space configured as a concatenation of a plurality of RAID groups (RG), each RAID group comprising N RG members, the method comprising:
a) caching in the cache memory a plurality of data portions matching a certain criterion, thereby giving rise to the cached data portions;
b) analyzing the succession of logical addresses characterizing the cached data portions;
c) if the cached data portions cannot constitute a group of N contiguous data portions, where N is the number of RG members, generating a virtual stripe being a concatenation of N data portions wherein at least one data portion among said data portions is non-contiguous with respect to any other portion in the virtual stripe, and wherein the size of the virtual stripe is equal to the size of the stripe of the RAID group;
d) destaging the virtual stripe and writing it to a respective storage device in a write-out-of-place manner.

2. The method of claim 1 wherein the data portions in the virtual stripe further meet a consolidation criterion.

3. The method of claim 2 wherein the consolidation criterion is selected from a group comprising criteria related to different characteristics of cached data portions and criteria related to desired storage location of the generated virtual stripe.

4. The method of claim 1 wherein the virtual stripe is generated responsive to receiving a given write request from a client, and wherein the cached data portions meet a criterion selected from the group comprising:
a) the cached data portions are constituted by data portions corresponding to the given write request and data portions corresponding to one or more write requests received before the given write request;
b) the cached data portions are constituted by data portions corresponding to the given write request, data portions corresponding to one or more write requests received before the given write request and data portions corresponding to one or more write requests received during a certain period of time after receiving the given write request;
c) the cached data portions are constituted by data portions corresponding to the given write request, and data portions corresponding to one or more write requests received during a certain period of time after receiving the given write request.

5. The method of claim 4 wherein said certain period of time is dynamically adjustable in accordance with one or more parameters related to a performance of the storage system.

6. The method of claim 1 wherein the virtual stripe is generated responsive to receiving a write instruction from a background process, and wherein the cached data portions meet a criterion related to the background process.

7. The method of claim 6 wherein the background process is selected from the group comprising defragmentation process, compression process, de-duplication process and scrubbing process.

8. The method of claim 1 wherein the control layer comprises a first virtual layer operable to represent the cached data portions with the help of virtual unit addresses corresponding to respective logical addresses, and a second virtual layer operable to represent the cached data portions with the help of virtual disk addresses (VDAs) substantially statically mapped into addresses in the physical storage space, the method further comprising:
a) configuring the second virtual layer as a concatenation of representations of the RAID groups;
b) generating the virtual stripe with the help of translating at least partly non-sequential virtual unit addresses characterizing data portions in the stripe into sequential virtual disk addresses, so that the data portions in the virtual stripe become contiguously represented in the second virtual layer; and
c) translating sequential virtual disk addresses into physical storage addresses of the respective RAID group statically mapped to second virtual layer, thereby enabling writing the virtual stripe to the storage device.

9. A storage system comprising a control layer operatively coupled to a plurality of storage devices constituting a physical storage space configured as a concatenation of a plurality of RAID groups (RG), each RAID group comprising N RG members, wherein the control layer comprises a cache memory and is further operable:
to cache in the cache memory a plurality of data portions matching a certain criterion, thereby giving rise to the cached data portions;
to analyze the succession of logical addresses characterizing the cached data portions;
if the cached data portions cannot constitute a group of N contiguous data portions, where N is the number of RG members, to generate a virtual stripe being a concatenation of N data portions wherein at least one data portion among said data portions is non-contiguous with respect to any other portion in the virtual stripe, and wherein the size of the virtual stripe is equal to the size of the stripe of the RAID group;
to destage the virtual stripe and to enable writing the virtual stripe to a respective storage device in a write-out-of-place manner.

10. The system of claim 9 wherein the data portions in the virtual stripe further meet a consolidation criterion.

11. The system of claim 10 wherein the consolidation criterion is selected from a group comprising criteria related to different characteristics of cached data portions and criteria related to desired storage location of the generated virtual stripe.

12. The system of claim 9 wherein the control layer is operable to generate the virtual stripe responsive to receiving a given write request from a client, and wherein the cached data portions meet a criterion selected from the group comprising:
a) the cached data portions are constituted by data portions corresponding to the given write request and data portions corresponding to one or more write requests received before the given write request;
b) the cached data portions are constituted by data portions corresponding to the given write request, data portions corresponding to one or more write requests received before the given write request and data portions corresponding to one or more write requests received during a certain period of time after receiving the given write request;
c) the cached data portions are constituted by data portions corresponding to the given write request, and data portions corresponding to one or more write requests received during a certain period of time after receiving the given write request.

13. The system of claim 12 wherein said certain period of time is dynamically adjustable in accordance with one or more parameters related to a performance of the storage system.

14. The system of claim 9 wherein the control layer is operable to generate the virtual stripe responsive to receiving a write instruction from a background process, and wherein the cached data portions meet a criterion related to the background process.

15. The system of claim 14 wherein the background process is selected from the group comprising defragmentation process, compression process, de-duplication process and scrubbing process.

16. The system of claim 9 wherein the control layer further comprises a first virtual layer operable to represent the cached data portions with the help of virtual unit addresses corresponding to respective logical addresses, and a second virtual layer operable to represent the cached data portions with the help of virtual disk addresses (VDAs) substantially statically mapped into addresses in the physical storage space, said second virtual layer is configured as a concatenation of representations of the RAID groups; and wherein the control layer is further operable:
to generate the virtual stripe with the help of translating at least partly non-sequential virtual unit addresses characterizing data portions in the stripe into sequential virtual disk addresses, so that the data portions in the virtual stripe become contiguously represented in the second virtual layer; and
to translate sequential virtual disk addresses into physical storage addresses of a respective RAID group statically mapped to second virtual layer, thereby enabling writing the virtual stripe to the storage device.

17. A computer program comprising computer program code means for performing all the steps of claim 1 when said program is run on a computer.

18. A computer program as claimed in claim 17 embodied on a computer readable medium.
